(19) United States
(12) Patent Application Publication
(10) Pub. No.: US 2008/0278936 A1
(43) Pub. Date: Nov. 13, 2008

(54) SURGICAL LIGHTS FREELY POSITIONABLE IN THE OPERATING THEATER

(75) Inventors: Paul A. Kurth, Santa Barbara, CA (US); Andrew W. Armour, Swarthmore, PA (US)

Correspondence Address: Law Offices of Daniel L. Dawes, 5200 Warner Blvd, Ste. 106, Huntington Beach, CA, 92649, US

(73) Assignee: Pressure Pruducts Medical Supplies, Inc., Santa Barbara, CA (US)

(21) Appl. No.: 11/745,401

(22) Filed: May 7, 2007

(51) Int. Cl. F21L 4/00

(52) U.S. Cl. 362/191

(57) ABSTRACT

The illustrated embodiment of the invention is directed to a sterile battery operated LED surgical light configured to be operated and manipulated during surgery attached to a surface which enters or is within a sterile field. The surgical light includes a sterile housing with a bottom surface and a front face adjacent to the bottom surface. A battery is disposed in the housing. An LED driver circuit is coupled to the battery and is disposed in the housing. At least one LED is disposed in the housing for transmitting light from the front face and is coupled to the LED circuit. A mechanism for powering the LED is disposed in the housing and is in circuit with the LED. A sterile self-adhesive backing is provided for releasably adhering to the surface within the sterile field. The backing is coupled to the housing.

### BACKGROUND OF THE INVENTION

1. Field of the Invention

The invention relates to the field of sterile surgical lighting for use in the surgical theater.

2. Description of the Prior Art

The current state-of-the-art in surgical lighting can basically be divided into three categories: 1) overhead lighting, 2) headlamps, and 3) specialty lighting.

Overhead lights are mounted to the ceiling or other large structures and are the main lights used by the physician to visualize the work area. These lights have high intensity bulbs (or now LED's) and can project a large amount of light down to the patient. Multiple lights over a larger area are used in an attempt to minimize shadows cast by the physician and personnel working beneath them. Some of these lights are equipped with sterile sleeves so that they may be positioned by the physician in the sterile field. These sleeves may touch a nonsterile area, or fall off, and thus can become awkward for the physician to manipulate as desired. As the lights are shining from above, they have to be continuously moved and angled so that the light is in a desirable location to the work area.

Headlamps are typically high powered lights worn by the physician on the head and can improve the lighting situation as they shine in the direction and angle that the physician is looking. These lights are nonsterile so they can not be adjusted by the physician in the sterile field. In an effort to change the direction of the light slightly, the physician is forced to alter his/her head position resulting in fatigue and sometimes painful spinal conditions.

Specialty lights have become available for lighting specific procedures, devices, and anatomy. Several of these lights are offered sterile, but are limited to a specific use.

What's needed is an easy to use, sterile light that can be operated and quickly adjusted by the physician to provide high intensity light where and when it is needed. The light could be attached, detached and re-attached to the physician's finger, gloved hand, drapes, any appropriate area of the patient's surgical site or to any other surface in the operating area. It would be inexpensive and disposable so that cleaning, disinfecting, and resterilization would not be required.

### BRIEF SUMMARY OF THE INVENTION

The illustrated embodiment of the invention is directed to a sterile battery operated LED surgical light configured to be operated and manipulated during surgery attached to a surface which enters or is within the surgical field comprising: a housing, which may be sterile, with a bottom surface and a front face adjacent to the bottom surface; a battery disposed in the housing; an LED driver circuit coupled to the battery and disposed in the housing; at least one LED disposed in the housing for transmitting light from the front face and coupled to the LED driver circuit; a switch or pull tab disposed in the housing and in circuit with the LED; and a sterile self-adhesive backing for releasably adhering to the surface within the sterile field, the backing being coupled to the housing.

In one embodiment the battery, LED driver circuit, LED, and switch are rendered sterile using conventional sterilization techniques.

In another embodiment the battery, LED driver circuit, LED, and switch are not sterile, but are sealed within the sterile housing.

The surgical light may further comprise a malleable stand having one portion coupled to the housing and another portion coupled to the self-adhesive backing.

The surgical light may further comprise a second adhesive backing coupling the stand to the housing. The stand is therefore adhered to the attachment surface in the surgical area, whatever it may be, and the housing of the surgical light is then attached to the stand instead of the attachment surface in the surgical theater. The light and the stand are therefore supplied separately, and combined, if at all, by the user in the field as the need arises.

Therefore, in one embodiment the backing is affixed directly to the housing.

The surgical light may also comprise a mechanical attachment mechanism, such as a clip to fasten the light to a gown, drape, surgical instrument, probe or also to a patient's tissue or organ.

The surgical light may further comprise a plurality of LEDs disposed in the housing to produce a beam of light.

In the preferred embodiment the self-adhesive backing has a water resistant adhesive.

The stand and light can also be supplied as an integral unit. In this case, a battery operated LED surgical light fixture configured to be operated and manipulated during surgery attached to a surface which enters or is within a surgical field comprises: a malleable stand having an attachment surface; a water resistant self adhesive backing or mechanical clip attached to the attachment surface of the stand, the backing having an exposed adhesive surface or mechanical clip for releasably adhering to a surface within the sterile field; a housing with a front face coupled to the stand; and at least one LED transmitting light from or through the front face and disposed in the housing. Both the light and stand may be sterile.

The surgical light fixture may further comprise a battery disposed in the housing; an LED driver circuit coupled to the battery and to the LED and disposed in the housing; and a switch disposed in the housing and in circuit with the LED.

In one embodiment the stand is coupled to the housing by a second adhesive backing adhering to the housing on one side of the backing and adhering to the stand on another side of the adhesive.

In another embodiment the housing and stand are mechanically coupled together, such as be a slip fitting between a molded bracket and sliding plate or any of a near limitless number of other mechanical arrangements such as a clip.

The illustrated embodiment of the invention is also defined as a method of using a, battery operated, adhesively or mechanically reattachable, LED surgical light within a surgical field comprising the steps of: selectively temporarily attaching the surgical light to a surface, instrument or device which enters or is within a surgical field by means of a self-adhesive backing or mechanical attachment and operating the light or manipulating the light, its position and angular orientation during surgery to illuminate a selected portion of the surgical field by means of its attachment to the selected surface, instrument or device within the surgical field.

The step of selectively and temporarily attaching the surgical light to a surface comprises selectively and temporarily attaching the surgical light to a surface by means of a malleable stand or any other instrument, probe or device and where manipulating the surgical light comprises the step of bending the stand to alter the position or orientation of the surgical light or manipulating the probe, instrument or device the light is attached to.

The step of selectively temporarily attaching the surgical light to a surface comprises the step of selectively temporarily attaching the surgical light to a gloved hand.

The step of selectively temporarily attaching the surgical light to a gloved hand comprises the step of selectively temporarily attaching the surgical light to a gloved finger of the gloved hand.

The step of selectively temporarily attaching the surgical light to a surface comprises the step of selectively temporarily attaching the surgical light to a surgical drape.

The step of selectively temporarily attaching the surgical light to a surface comprises the step of selectively temporarily attaching the surgical light to a medical device in or near the operating theater.

The step of selectively temporarily attaching the surgical light to a surface comprises the step of selectively temporarily attaching the surgical light to the patient.

The step of selectively temporarily attaching the surgical light to a surface comprises the step of selectively temporarily attaching the surgical light to a malleable stand which is in turn temporarily attached to a portion of a person working within the surgical theater, a patient within the surgical theater or an inanimate object within the surgical theater.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a photograph of the illustrated embodiment of the light shown mounted to the top surface of a gloved finger of a left hand of a surgeon and directed thereby to a site of operation of surgical tools, including one held by the same hand to which the light is attached.

FIG. 2 is a photograph of the illustrated embodiment of the light shown in FIG. 1 as seen from the opposite hand to that to which the light is mounted.

FIG. 3 is a photograph of the illustrated embodiment of the light shown with a malleable metal stand.

FIG. 4 is diagrammatic side cross-sectional view of the surgical light shown in FIGS. 1-3.

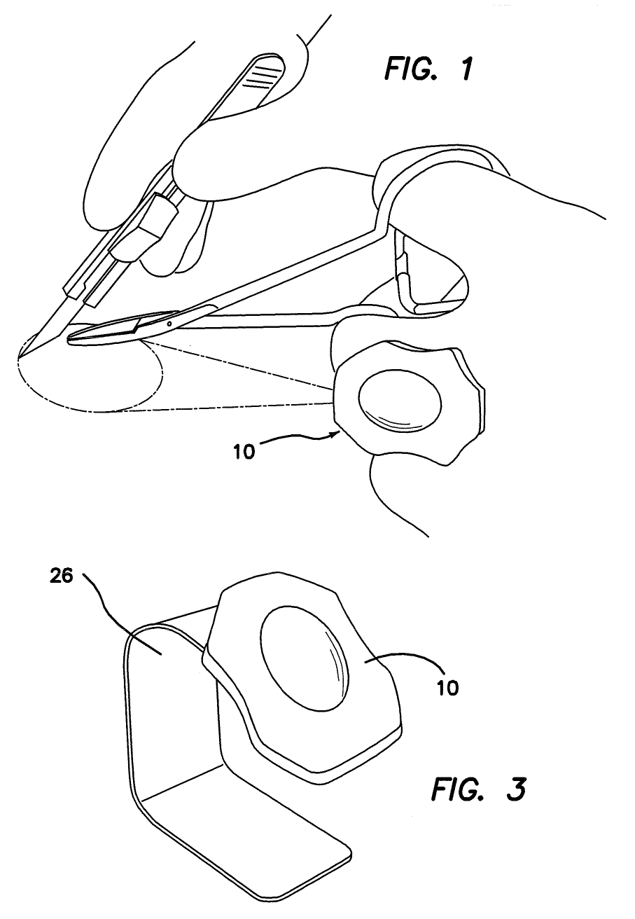

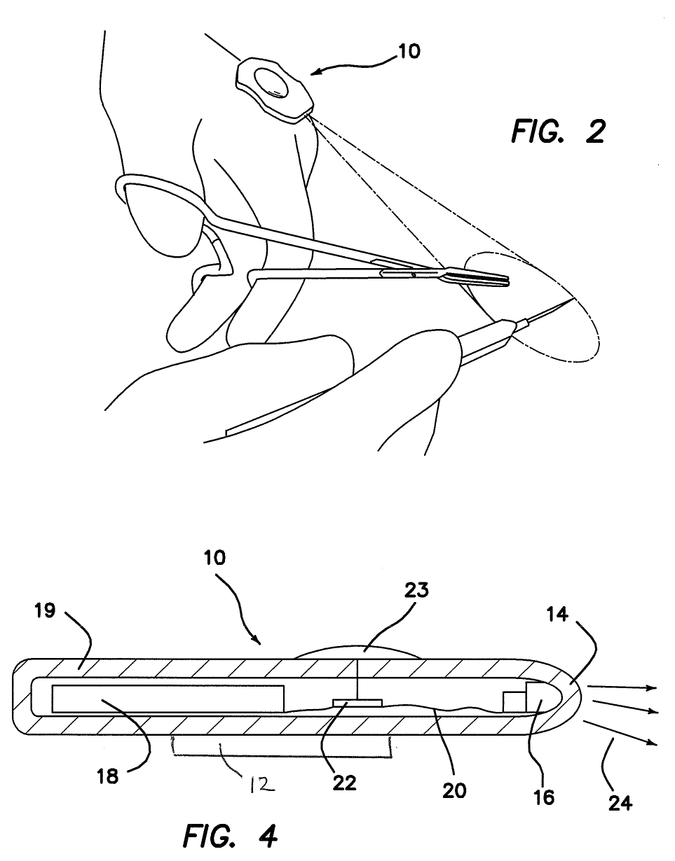

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The illustrated embodiment is a high intensity, inexpensive, sterile, disposable, battery operated, white LED, surgical light 10 which satisfies the need discussed above. While the preferred embodiment uses a white or near white light, it is to be understood any color of light may be employed, including color variable lights wherever such a feature can be utilized to advantage. For example, the light includes an ultraviolet light which will cause specifically tagged tissue to fluoresce.

The light 10 may be provided in a sterile condition so it can be operated, and adjusted by the physician in the sterile field. It incorporates a self-adhesive, reusable backing 12 shown in side view in FIG. 4 that allows the light to be adhered to the gloves, apparel, flexible stands, drapes, the patient's skin or other sterile areas so as to get the light exactly where it is needed. Backing 12 is affixed to a back surface of light 10 by adhesive or any means conventionally employed for affixing adhesive backings to plastic objects. A battery 18 is included in a housing 19, typically made of transparent plastic, and is coupled to a circuit board 20 on which an LED driver chip 22 is placed in circuit with battery 18 and LED 16. A typical LED driver is a model ZXSC310 driver circuit from Zetex Semiconductors of Hauppague, N.Y. Pulse width modulation (PWM) oscillators can also be used in LED driver circuits. Many different kinds of LED driver circuits can be employed and the choice of which is used, if any, does not limit the scope of the invention. Alternatively, LED 16 may be directly driven and connected to battery 18. LED 16 may include its own protective packaging which may also include conventional reflectors and lenses for collecting and directing the light from LED 16 in a focused, collimated or partially collimated beam 24. In the illustrated embodiment a beam 24 is focused to a distance which equals or exceeds the expected distances which will be normally encountered by light 10 in an operating theater, for example in the illustrated embodiment LED 16 has an approximate 20 degree projection angle which creates a 2 inch diameter beam at a distance of approximately 4.5 inches.

A sealed switch 23 is provided in housing 19 and is in circuit in a function manner with LED 16 to turn LED 16 on and off. Switch 23 is sealed in a manner to allow operation of switch 23 without comprising the sterile seal provided by housing 19 for all the components within it. Alternatively, housing 19 need not be sealed, but may include a small opening to allow the interior of housing 19 to be sterilized by EO gas. Housing 19, while not necessarily airtight, is sufficiently closed to prevent any substantial amount of exterior fluids to enter housing 19. Typically a thin flexible membrane of the material of housing 19, or a material bonded to it, covers switch 23, which is a toggled push button switch. Although a simple on/off function is contemplated for switch 23, it is also possible to allow more complex programmed states to be activated by toggling or momentarily opening or closing switch 23 to step through a preprogrammed operation or holding switch 23 down for a predetermined time period to direct operation of light 10 into a preprogrammed mode in a manner analogous to the use of push button switches on digital watches.

Alternatively, instead of a switch 23, the switching function can be served by an insulating tab, which serves to break the connection between battery 18 and LED 16 when the tab is in place, but when the tab is pulled from the housing 19, the connection between battery 18 and LED 16 is completed, such as by allowing a resilient pair of contacts to make electrical connection with each other. In this sense, switch 23 should be understood to include such a pull tab or any other means for making or interrupting electrical connection between battery 18 and LED 16.

LED 16 is a model NSPW500CS manufactured by Nichia Corporation of Tokyo, Japan. The power output of LED 16 is 0.1 watt and produces 11000-31000 mcd. Battery 18, which is understood to include one or more separate battery units as may be needed, in the illustrated embodiment is a model 2016 (2032 also being contemplated) lithium battery cell manufactured by Energizer Corporation of St. Louis, Mo. USA and is capable of powering light 10 for 1 (2 hours for 2032) hours continously at the above power output. High brightness can be maintained by using multiple batteries which are sequentially switching into connection with LED 16 with a timing circuit. Current is thus drawn from the batteries at maximal rates for optimal times, then switched out to recover in a cyclical process. Other brightness and battery management solutions include, but are not limited to, constant current pulse LED drivers, which use an inductor to buck or boost the voltage to the LED and deliver a constant current through a high frequency pulse. As referenced above PWM oscillators may also be used to increase the pulse frequency as the battery level drains to provide a constant brightness throughout the battery life. Light 10 in the illustrated embodiment is not rechargeable nor intended for more than one use, since it is not intended to be resterilized after its first use. However, appropriate modifications can be made to battery 18 and light 10 to render it reusable and resterilizable if desired. Battery 18 may be replaceable or rechargeable. It is to be understood that the component parts listed above are illustrative only, and than many different other kinds of components can be provided without departing from the spirit and scope of the invention. LED 16 may be entirely encapsulated within housing 19 and transmit its light through a thin window defined in the front side of housing 19, or an aperture may be defined in the front side of housing 19 to allow LED 16 or at least its packaging and optical lenses to extend therethrough. The sterility of LED 16 or extended packaging and optical lenses with housing 19 is then maintained by effecting a tight seal between the aperture and the LED 16 or extended packaging and optical lenses.

The adhesive on backing 12 it water resistant, so that it can be used in a wet environment without adhesive difficulty, including gentle adhesion to wet tissue. The adhesive allows it to be repositioned multiple times without compromising the adhesive properties.

In FIG. 3 a malleable metal stand 26 is included with the light that allows it serve as an infinitely adjustable work light stationed right next to the surgical work area. The metal stand 26 also incorporates a self adhesive backing 12 that allows it to adhere to any surface in the sterile field. Stand 26 may be fabricated out of any malleable material and is not limited to metal, but in the illustrated embodiment soft aluminum, alloy 1100, is employed, such as manufactured by Century Aluminum of Monterey, Calif. USA.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

For example, It is contemplated expressly that a plurality of identical LEDs 16 may be employed to provide a line source of light or a two dimensional source of light to provide a broad field of illumination.

Still further stand 26 need not be limited to a flat curved strip form as shown in FIG. 3, but may include a complexly shaped wire frame embedded in or affixed to adhesive backing 12, like a duck's webbed foot. In this embodiment, stand 26 can be molded around any shaped object to clasp the object both mechanically and/or by means of the adhesive. As an example, such a webbed foot stand could be closely molded by the physician to the patient's nose, ear or other arbitrarily shaped body part, if the medical procedure were to be conducted in the vicinity of that body part.

In the same spirit, housing 19 could be shaped in forms other than a small flat prismatic body. Instead of being flat, the rear surface of housing 19 could be curved to approximate the curvature of a finger or side of the palm in those cases where those surfaces were intended to provide the mounting surface for light 10. Similarly, housing 19 need not be made from rigid plastic, but may have a degree of malleability as well which is accommodated by use of a flexible circuit board or ribbon in light 10 and more open cavities for accepting battery 18 and LED 16 to permit relative displacement of housing 19 with respect to the interior components held within it.

While one LED 16 is shown in the illustrated embodiment of light 10 it is expressly contemplated that multiple LEDs 16, which each may be identical or different, could be employed together with such additional active or passive optical elements as may be desired in combining or optically transforming the individual beams of each LED 16 to provide a composite beam or multiple separate beams as may be used to advantage in any given application.

While the illustrated embodiment shows the LED positioned on the front surface of the housing, it is within the scope of the invention that the LED may occupy any surface (top, bottom, side or front) of the LED housing.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A surgical light for use in a surgical field comprising:
a housing;
at least one battery disposed in the housing;
at least one LED disposed in the housing and coupled to the at least one battery;
a means for turning on the at least one LED; and
adhering or attachment means for releasably coupling to a surface within the surgical field.

2. The surgical light of claim 1 where the battery, LED and means for turning on the LED are sterile.

3. The surgical light of claim 1 where the adhering or attachment means comprises an adhesive layer.

4. The surgical light of claim 1 further comprising a malleable stand having a portion coupled to the housing and another portion coupled to the adhering or attachment means, the malleable stand being attachable and detachable to the surgical field.

5. The surgical light of claim 1 further comprising a control circuit for providing approximately constant brightness of the at least one LED.

6. The surgical light of claim 1 where the means for turning on the LED comprises a mechanical switch, an electronic momentary switch or a tab for enabling selective coupling between the at least one battery and LED.

7. A sterile surgical light for use within a surgical field comprising:
a housing;
at least one LED located within the housing;
at least one battery located with in the housing;
a driver circuit electrically coupled to the at least one battery for driving the at least one LED;
means for selectively providing power from the at least one battery to the at least one LED; and
adhesive means for releasably coupling to a surface within the surgical field for coupling the housing to the surface.

8. The surgical light of claim 7 where the adhesive means comprises a water resistant adhesive layer.

9. The surgical light of claim 7 further comprising a malleable stand which is attachable and detachable to the surgical field by the adhesive means.

10. The surgical light of claim 7 further comprising a control circuit for maintaining approximately constant brightness of the at least one LED coupled to the at least one LED.

11. The surgical light of claim 7 where the means for selective providing power from the at least one battery to the LED comprises a mechanical switch, an electronic momentary switch or a tab for enabling selective coupling between the at least one battery and LED.

12. A sterile surgical light for use within a surgical field comprising:
a housing;
at least one LED located within the housing;
at least one battery located with in the housing;
a driver circuit electrically coupled to the at least one battery for driving the at least one LED;
means for selectively providing power from the at least one battery to the at least one LED; and
a malleable stand coupled to the housing which is attachable and detachable to the surgical field.

13. The light of claim 12 further comprising a control circuit for providing approximately constant brightness of the at least one LED coupled to the at least one LED.

14. The surgical light of claim 12 where the means for selectively providing power from the at least one battery to the at least one LED comprises a mechanical switch, an electronic momentary switch or a tab for enabling selective coupling between the at least one battery and LED.

15. A sterile surgical light for use within a surgical field comprising:
a housing;
at least one LED located within the housing;
two batteries electrically coupled together in series and located with in the housing;
a driver circuit electrically coupled to the two batteries for driving the at least one LED;
a control circuit for providing approximately constant brightness of the at least one LED coupled to the at least one LED; and
attachable and detachable means for adhesively coupling to a surface within the surgical field using water resistant adhesive.

16. The surgical light of claim 15 further comprising means for selectively providing power from the two batteries to the at least one LED which includes a mechanical switch, an electronic momentary switch, or a tab for enabling selective coupling between the at least one battery and LED.

17. A method of operating a surgical light in a surgical field comprising:
providing a housing, at least one battery disposed in the housing, at least one LED disposed in the housing and coupled to the at least one battery;
turning on the at least one LED; and
releasably coupling the housing to a surface within the surgical field.

18. The method of claim 17 where releasably coupling the housing to the surface within the surgical field comprises adhesive coupling the housing to the surface using a malleable stand having a portion coupled to the housing and another portion coupled to an adhesive layer.

19. The method of claim 17 where the at least one battery has an effective lifetime and further comprising controlling the brightness of the at least one LED to maintain approximately constant brightness during the at least one battery lifetime.

20. The method of claim 17 where turning on the LED comprises operating a mechanical switch or an electronic momentary switch or manipulating a tab to enable selective coupling between the at least one battery and LED.
